(19) United States
(12) Patent Application Publication
(10) Pub. No.: US 2023/0369723 A1
(43) Pub. Date: Nov. 16, 2023

(54) BUSBAR

(71) Applicant: Yazaki Corporation, Tokyo (JP)

(72) Inventor: Hiroyasu TAKAGI, Shizuoka (JP)

(73) Assignee: Yazaki Corporation, Tokyo (JP)

(21) Appl. No.: 18/311,588

(22) Filed: May 3, 2023

(30) Foreign Application Priority Data
May 10, 2022 (JP) 2022-077608

(51) Int. Cl. H01M 50/505; H01M 50/512

(52) U.S. Cl. CPC H01M 50/505; H01M 50/512

(57) ABSTRACT

A busbar includes a first busbar part having a first connection part that is connected to a connection target object, and a first conductive part that is connected continuous to the first connection part. Further, the busbar includes a second busbar part having a second connection part that is connected to a connection target object different from the connection target object that is connected to the first connection part, and a second conductive part that is connected continuous to the second connection part and has a greater resistance value than that of the first conductive part. A current diverting part that diverts a current is formed in the first conductive part such that a shortest path of the current flowing through the first conductive part increases in length.

### CROSS-REFERENCE TO RELATED APPLICATIONS

The present application is based on, and claims priority from the prior Japanese Patent Application No. 2022-077608, filed on May 10, 2022, the entire contents of which are incorporated herein by reference.

### BACKGROUND OF THE INVENTION

### Technical Field

The disclosure relates to a busbar.

### Background

JP 2021-136238 A discloses a busbar including a plurality of busbar parts. The plurality of busbar parts have connection parts connected to batteries serving as connection target objects, and conductive parts connected continuous to the connection parts. The plurality of busbar parts have at least one busbar part in which the resistance value of the conductive part is different from those of the other busbar parts.

### SUMMARY OF THE INVENTION

When a busbar has a plurality of types of busbar parts having different resistance values of the conductive parts as in the above conventional technology, this causes a variation in the load that is applied to the connection target object that is connected to the connection part of each busbar part.

Thus, in the conventional technology, when a busbar has a plurality of types of busbar parts, there is a problem in that there is a variation in the load that is applied to a plurality of connection target objects.

An object of the present disclosure is to provide a busbar that is capable of suppressing a variation in the load that is applied to a plurality of connection target objects even when the busbar has a plurality of types of busbar parts.

A busbar according to an embodiment includes: a first busbar part having a first connection part that is connected to a battery, and a first conductive part that is connected continuous to the first connection part; and a second busbar part having a second connection part that is connected to a battery different from the battery that is connected to the first connection part, and a second conductive part that is connected continuous to the second connection part and has a greater resistance value than that of the first conductive part. A current diverting part that diverts a current is formed in the first conductive part such that a shortest path of the current flowing through the first conductive part increases in length, thereby increasing an amount of heat generation in the first conductive part to be more than when the current diverting part is not formed.

Another busbar according to an embodiment includes: a first busbar part having a first connection part that is connected to a connection target object, and a first conductive part that is connected continuous to the first connection part; and a second busbar part having a second connection part that is connected to a connection target object different from the connection target object that is connected to the first connection part, and a second conductive part that is connected continuous to the second connection part and has a greater resistance value than that of the first conductive part. A current diverting part that diverts a current is formed in the first conductive part such that a shortest path of the current flowing through the first conductive part increases in length.

### BRIEF DESCRIPTION OF DRAWINGS

FIG. 1 is a plan view illustrating an example of a state in which a plurality of batteries are connected using a busbar according to a first embodiment.

FIG. 2 is a partially enlarged plan view illustrating a state in which an insulating member is provided to fill a slit formed in the busbar according to the first embodiment.

FIG. 3 is a partially enlarged plan view illustrating a state in which an insulating member is provided to cover the slit formed in the busbar according to the first embodiment.

FIG. 4 is a plan view illustrating an example of a state in which a plurality of batteries are connected using a busbar according to a second embodiment.

FIG. 5 is a plan view illustrating an example of a state in which a plurality of batteries are connected using a busbar according to a third embodiment.

FIG. 6 is a plan view illustrating an example of a state in which a plurality of batteries are connected using a busbar according to a fourth embodiment.

FIG. 7 is a plan view illustrating a slit according to a first modified example.

FIG. 8 is a plan view illustrating a slit according to a second modified example.

### DETAILED DESCRIPTION OF THE INVENTION

Various embodiments will be described hereinafter with reference to the accompanying drawings.

Hereafter, a busbar according to the present embodiment will be described in detail with reference to the drawings. Note that the dimensional ratios in the drawings are exaggerated for convenience of the explanation and may differ from the actual ratios.

In the following, an example using a battery as a connection target object will be given, and a description will be given with the up-down direction being defined in a state in which the battery (connection target object) is positioned downward and the busbar is positioned upward.

In addition, the same components are included in the following embodiments and the modified examples thereof. Therefore, in the following description, the same reference numerals are given to the same components, and a description thereof will be omitted.

### First Embodiment

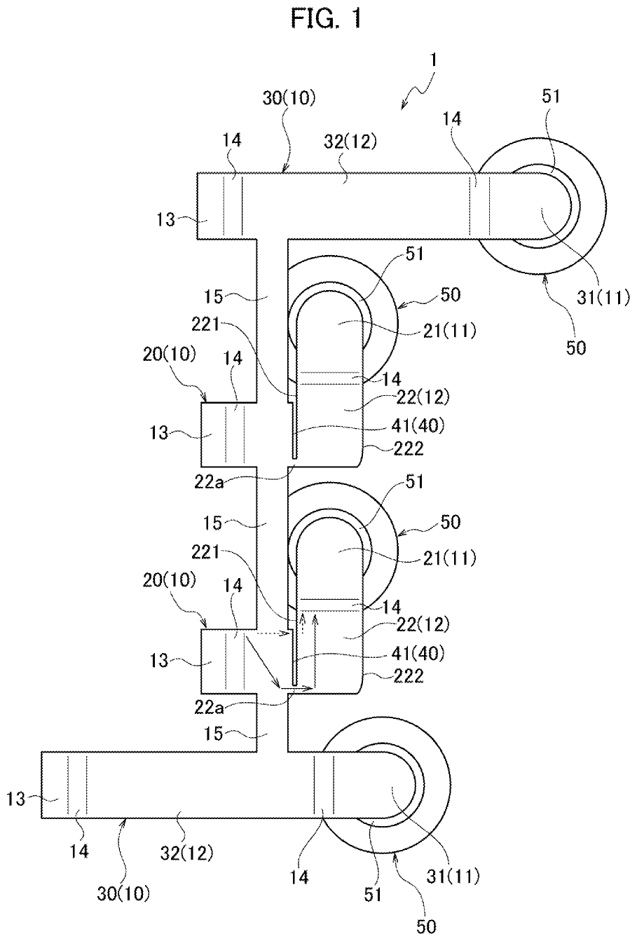

As illustrated in FIG. 1, a busbar 1 according to the present embodiment includes a plurality of busbar parts 10. The plurality of busbar parts 10 each have a connection part 11 that is electrically connected to a battery 50 (connection target object), and a conductive part 12 that is connected continuous to the connection part 11.

In the present embodiment, the busbar 1 includes four busbar parts 10, and the four busbar parts 10 are connected with one another by coupling parts 15. That is, the busbar 1 according to the present embodiment is formed by integrating the four busbar parts 10 with three coupling parts 15.

The busbar 1 can be formed by processing (e.g. pressing or bending) a metal plate, for example.

The connection parts 11 of the busbar parts 10 are connected to the four batteries 50, respectively. In the present embodiment, the connection parts 11 of the busbar parts 10 are electrically connected to positive electrodes (electrode terminals) 51 of the batteries 50, respectively. At such time, the four batteries 50 are held by a member such as a battery holder (not illustrated).

That is, the busbar 1 according to the present embodiment is used to connect the four batteries 50 in parallel. It is also possible to connect the four batteries 50 in parallel by connecting the connection parts 11 of the busbar parts 10 to negative electrodes (electrode terminals) of the batteries 50, respectively. It is also possible to connect the four batteries 50 in series.

Each battery 50 (connection target object) can be used as a part of a battery module mounted on an electric vehicle (for example, a HV, PHV, EV, FCV, or the like), and for example, a lithium-ion battery can be used as such a battery 50 (connection target object). In the present embodiment, a cylindrical battery is used as an example. In addition, a rectangular-cylinder or pouch-type battery may be used.

In the present embodiment, an other-side connection part 13 is connected continuous to the side opposite to the side where the conductive part 12 of each busbar part 10 is connected continuous to the connection part 11. The other-side connection part 13 is a part that is electrically connected to a connector or the like that is connected to another battery or an ECU (electrical control unit).

Further, in the present embodiment, a bent part 14 is formed between the conductive part 12 and the connection part 11 and between the conductive part 12 and the other-side connection part 13, and such that the connection part 11 and the other-side connection part 13 are positioned lower than the conductive part 12 (the side where the battery 50 is disposed). This prevents the conductive part 12 from interfering with the connection target object such as the battery 50 when the connection part 11 and the other-side connection part 13 are connected to the connection target object such as the battery 50.

In the present embodiment, the busbar 1 has two types of busbar parts with different lengths of the conductive parts 12.

Specifically, the busbar 1 includes two first busbar parts 20 each having a first connection part 21 that is connected to a battery 50, and a first conductive part 22 that is connected continuous to the first connection part 21. In addition, the busbar 1 includes two second busbar parts 30 each having a second connection part 31 that is connected to a battery 50 different from the batteries 50 that are connected to the first connection parts 21, and a second conductive part 32 that is connected continuous to the second connection part 31 and is longer than the first conductive parts 22.

A busbar having two types (plural types) of busbar parts such as these is often used when it is necessary to have a fixed configuration due to, for example, dimensional constraints. In other words, a busbar having two types (plural types) of busbar parts is often used when the position of a battery 50 (connection target object) or the position of the busbar 1 is limited.

In the present embodiment, the first conductive part 22 and the second conductive part 32 are substantially the same in width and thickness, and the first conductive part 22 has a shorter length than the second conductive part 32. In addition, the first busbar part 20 and the second busbar part 30 are made of the same material. Therefore, in the present embodiment, the second conductive part 32 has a greater resistance value than that of the first conductive part 22.

Thus, when there are two types of conductive parts 12 (the first conductive part 22 and second conductive part 32) with different resistance values, the amount of heat generated when a current is applied to each conductive part 12 differs between the first conductive part 22 and the second conductive part 32. Specifically, when a current is applied to each conductive part 12 (the first conductive part 22 and second conductive part 32), the amount of heat generated per unit time in each conductive part is different between the first conductive part 22 and the second conductive part 32.

When the amount of heat generated per unit time is different between the first conductive part 22 and the second conductive part 32, the amount of heat transferred to the battery 50 that is connected to the first connection part 21 is different from the amount of heat transferred to the battery 50 that is connected to the second connection part 31. When the amount of heat per unit time transferred to the battery 50 is different depending on the connection destination, the deterioration rate caused by the heat of the battery 50 is different.

Thus, when the busbar 1 has two types of conductive parts 12 with different resistance values, the variation in the deterioration rate caused by the heat of the plurality of batteries 50 increases. Therefore, even when the busbar 1 has two types of conductive parts 12 with different resistance values, it is preferable to reduce the variation in the deterioration rate caused by the heat of the plurality of batteries 50. In particular, it is preferable to reduce the variation in the deterioration rate caused by the heat of the plurality of batteries 50 even when it is necessary to have a fixed configuration due to dimensional constraints.

Accordingly, in the present embodiment, the amount of heat per unit time transferred to the battery 50 is made nearly uniform by eliminating the variation between the resistance value of the first conductive part 22 and the resistance value of the second conductive part 32.

In this respect, it is preferable that the resistance value of the second conductive part 32 be made to match the resistance value of the first conductive part 22 having a shorter distance and a lower resistance value. However, in order to reduce the resistance value of the second conductive part 32 having a longer distance, it is necessary to increase the second conductive part 32 in width and thickness, and thus in a case where it is necessary to have a fixed configuration due to dimensional constraints, this method cannot be employed.

For this reason, in the present embodiment, the variation between the resistance value of the first conductive part 22 and the resistance value of the second conductive part 32 is eliminated by intentionally increasing the resistance value of the first conductive part 22 which has a lower resistance value than the second conductive part 32.

In this respect, if the entire width of the first conductive part 22 is reduced, it is possible to increase the resistance value of the first conductive part 22 even when it is necessary to have a fixed configuration due to dimensional constraints or the like. However, if the entire width of the first conductive part 22 is reduced, the mechanical strength cannot be ensured because the entire first conductive part 22 becomes thinner. Thus, there is a risk that the first conductive part 22 may break when an impact is applied thereto. In addition, since the first conductive part 22 also changes in shape, it becomes susceptible to vibration from the outside. Further, as the entire first conductive part 22 becomes thinner, the area of the first conductive part 22 also becomes smaller, and thus the heat radiation effect thereof also decreases.

Accordingly, if the first conductive part 22 significantly changes in shape, it becomes difficult to make the amount of heat per unit time transmitted to the battery 50 uniform.

Therefore, in the present embodiment, the resistance value of the first conductive part 22 can be adjusted without changing the shape of the first conductive part 22 as much as possible, and thus the amount of heat generated can be adjusted in such a way as to eliminate the variation.

Specifically, a current diverting part 40 that diverts a current is formed in the first conductive part 22 such that the shortest path of the current flowing through the first conductive part 22 increases in length, and thus the resistance value of the first conductive part 22 is greater than when the current diverting part 40 is not formed. This makes it possible to increase the amount of heat generated in the first conductive part 22. In the present embodiment, a slit 41 is formed in the first conductive part 22 such that the slit 41 functions as the current diverting part 40. That is, the current diverting part 40 has the slit 41.

In the present embodiment, the first conductive part 22 has a shape bent at an approximate right angle in plan view. Accordingly, the travel distance of the flow along the inner contour 221 of the first conductive part 22 is shorter than that of the flow along the outer contour 222. That is, when the current diverting part 40 is not formed, the path along the inner contour 221 of the first conductive part 22 is the shortest path of the current (see the dashed arrows in FIG. 1).

Therefore, in the present embodiment, the slit 41 (the current diverting part 40) is provided in the first conductive part 22 so as to divide the shortest path of the current that would (otherwise) exist if the current diverting part 40 were not formed, into a path on one side of the slit 41 and a path on the other side of the slit 41. As a result, air exists in the slit 41. That is, by providing the slit 41 to divide the portion of the first conductive part 22 that is the shortest path of the current, the shortest path is separated by air through which the current does not pass, and thus no current flows in the portion where the slit 41 (the current diverting part 40) is formed.

This diverts the current flowing in the first conductive part 22, and thus the shortest path of the current flowing in the first conductive part 22 is formed to be long (see the solid arrows in FIG. 1).

Accordingly, in the present embodiment, when the resistance value of each busbar part is different and the amount of heat generated is different, a slit is formed in the shorter busbar part, and thus the resistance value of the shorter busbar part is the same as that of the longer busbar part, thereby adjusting the amount of heat generated in each busbar part.

Therefore, the resistance value of the first conductive part 22 and the amount of heat generated in the first conductive part 22 per unit time can be adjusted without changing the shape (entire width: contour shape in plan view) and the surface area of the first conductive part 22 as much as possible. That is, the resistance value of the first conductive part 22 and the amount of heat generated in the first conductive part 22 per unit time can be adjusted in addition to maintaining the mechanical strength of the first conductive part 22 and suppressing a reduction in the heat radiation effect. For this reason, the amount of heat generated in the first conductive part 22 can be easily adjusted, thereby making it possible to design the first conductive part 22 more easily.

When the slit 41 is provided in the first conductive part 22, a narrow conductive path 22a through which the diverted current passes is formed at the tip side of the slit 41. In the present embodiment, since the slit 41 is provided to adjust the resistance value and heat generated in the first conductive part 22 by increasing the length of the shortest path of the current, it is necessary to prevent the slit 41 from being fused by the heat generated by the current flowing through the first conductive part 22. For this reason, it is preferable that the conductive path 22a have a width with which fusing does not occur even when the maximum overcurrent that is assumed for use in a product such as a battery module flows. Therefore, in a case where there is a risk that the conductive path 22a may be fused when one slit 41 is formed to thereby achieve a desired resistance value, it is preferable that the width of the conductive path 22a be changed to a width with which it is assumed that fusing will not occur by forming a plurality of slits.

Further, when the slit 41 is formed as in the present embodiment, even in a case where the heights of the batteries 50 vary, the portion adjacent to the slit 41 of the first conductive part 22 is easily elastically deformed, thereby making it possible to allow for a difference in the heights of the batteries 50.

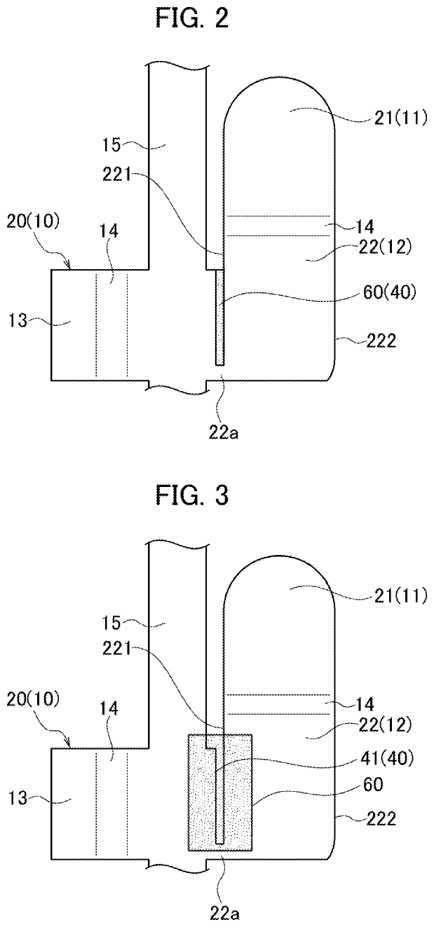

In addition, as illustrated in FIG. 2, when the resistance value of the first conductive part 22 increases, an insulating member 60 with electrical insulation properties may be provided in the portion through which it is desired that a current does not pass (the portion corresponding to the slit 41 in FIG. 1). That is, the path of the first conductive part 22 that is usually the shortest can be separated by using a material that does not allow the current to pass (the insulating member 60 with electrical insulation properties). This insulating member 60 can be formed using ceramic, resin, or the like. In addition, a material (not illustrated) that allows the current to pass and has a high resistance value can be provided in the portion through which it is desired that a current does not pass (the portion corresponding to the slit 41 in FIG. 1). That is, the path of the first conductive part 22 that is usually the shortest can be separated by using a material (not illustrated) which allows the current to pass and has a high resistance value.

In addition, the insulating member 60 can be formed so as to fill the slit 41 formed in advance. When the busbar 1 is manufactured, it may be formed simultaneously with the first conductive part 22. That is, the insulating member 60 can be formed in the portion through which it is desired that a current does not pass, without forming the slit 41 in advance.

This configuration makes it possible for the insulating member 60 to function as the current diverting part 40, thereby making it possible to suppress a reduction in the mechanical strength of the first conductive part 22 as much as possible. In other words, it is possible to have the same strength as before the resistance adjustment.

In addition, as illustrated in FIG. 3, the insulating member 60 can be formed in the slit 41 formed in advance and in the periphery of the slit 41. This insulating member 60 can be formed, for example, by covering the slit 41 and the periphery thereof with a resin mold.

This configuration also makes it possible for the insulating member 60 to function as the current diverting part 40, thereby making it possible to suppress a reduction in the mechanical strength of the first conductive part 22 as much as possible. In other words, it is possible to have the same strength as before the resistance adjustment.

FIG. 3 illustrates an example in which the insulating member 60 is provided only in the slit 41 and the periphery thereof; however, the present embodiment is not limited to such a configuration and various configurations are possible. For example, the insulating member 60 may be formed in such a way as to follow the shape of the busbar part 10, and the entire busbar part 10 may be covered by the insulating member 60. In addition, the entire busbar part 10 may be covered by the insulating member 60, the outline shape of which in plan view is rectangular and larger than the shape of the busbar part 10.

### Second Embodiment

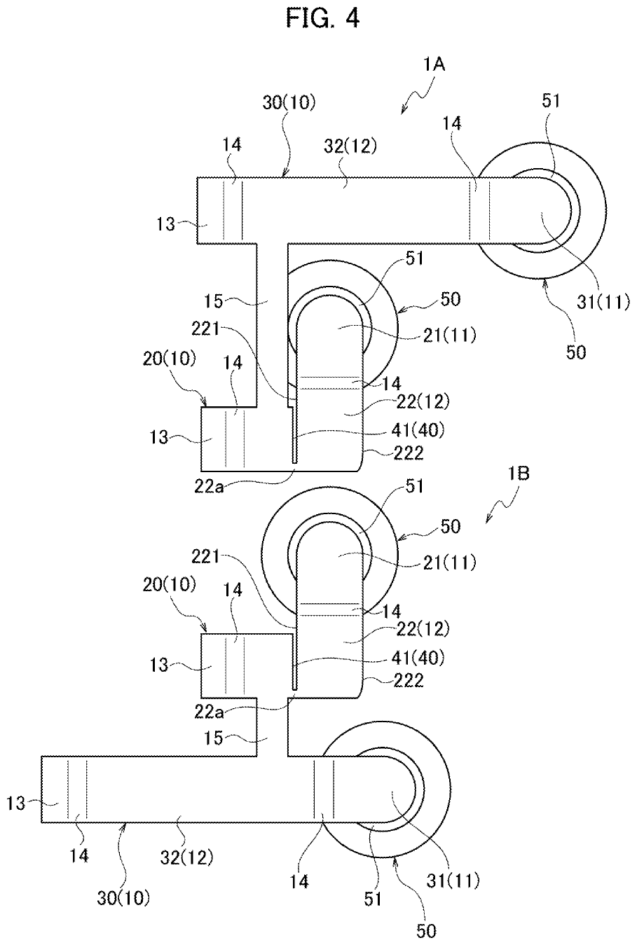

In the second embodiment, four batteries 50 (connection target objects) are connected using two busbars, that is, a busbar 1A and a busbar 1B, as illustrated in FIG. 4.

Specifically, the busbar 1A has a shape in which two busbar parts 10 are connected by a coupling part 15, and the busbar 1A has two types (plural types) of busbar parts, that is, the first busbar part 20 and the second busbar part 30.

Similarly, the busbar 1B has a shape in which two busbar parts 10 are connected by the coupling part 15, and the busbar 1B has two types (plural types) of busbar parts, that is, the first busbar part 20 and the second busbar part 30.

Further, two batteries 50 are connected in parallel to two connection parts 11 (a first connection part 21 and a second connection part 31) of the busbar 1A.

Similarly, two batteries 50 are connected in parallel to two connection parts 11 (a first connecting part 21 and a second connecting part 31) of the busbar 1B.

Further, a slit 41 is formed as a current diverting part 40 in the first conductive part 22 of the busbar 1A and the busbar 1B.

This reduces the variation between the resistance value of the first conductive part 22 and the resistance value of the second conductive part 32 of the busbar 1A. In addition, this reduces the variation between the resistance value of the first conductive part 22 and the resistance value of the second conductive part 32 of the busbar 1B. In addition, the second embodiment makes it possible to reduce the variation between the resistance values of the first conductive part 22 of the busbar 1A, the second conductive part 32 of the busbar 1A, the first conductive part 22 of the busbar 1B, and the second conductive part 32 of the busbar 1B.

As a result, the amount of heat generated per unit time is made almost equal in the four busbar parts.

This makes it possible for the configuration of the second embodiment to have the same functional effect as that of the first embodiment.

### Third Embodiment

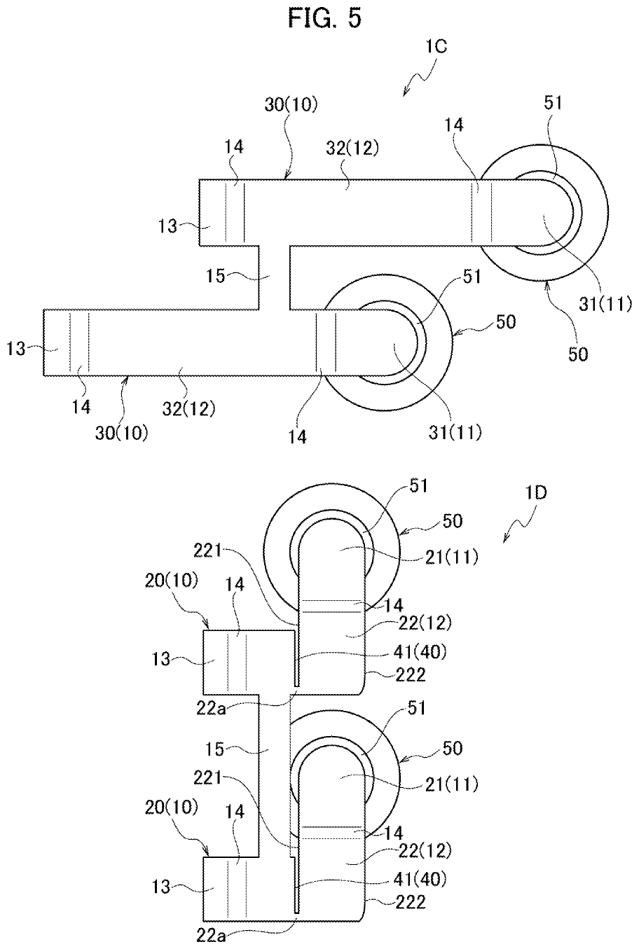

In the third embodiment, four batteries 50 (connection target objects) are connected using two busbars, that is, a busbar 1C and a busbar 1D, as illustrated in FIG. 5.

Specifically, the busbar 1C has a shape in which two busbar parts 10 are connected by a coupling part 15, and the busbar 1D also has a shape in which two busbar parts 10 are connected by a coupling part 15.

Further, the busbar 1C has two second busbar parts 30, and the busbar 1D has two first busbar parts 20. That is, in the present embodiment, the busbar 1C and the busbar 1D has two types (plural types) of busbar parts.

Further, two batteries 50 are connected in parallel to two connection parts 11 (second connecting parts 31) of the busbar 1C.

Similarly, two batteries 50 are also connected in parallel to two connection parts 11 (first connecting parts 21) of the busbar 1D.

Further, slits 41 are formed as current diverting parts 40 in the two first conductive parts 22 of the busbar 1D.

This reduces the variation between the resistance value of the first conductive part 22 of the busbar 1D and the resistance value of the second conductive part 32 of the busbar 1C, and thus the amount of heat generated per unit time 10 is made almost equal in the four busbar parts.

This makes it possible for the configuration of the third embodiment to have the same functional effect as those of the first embodiment and second embodiment.

### Fourth Embodiment

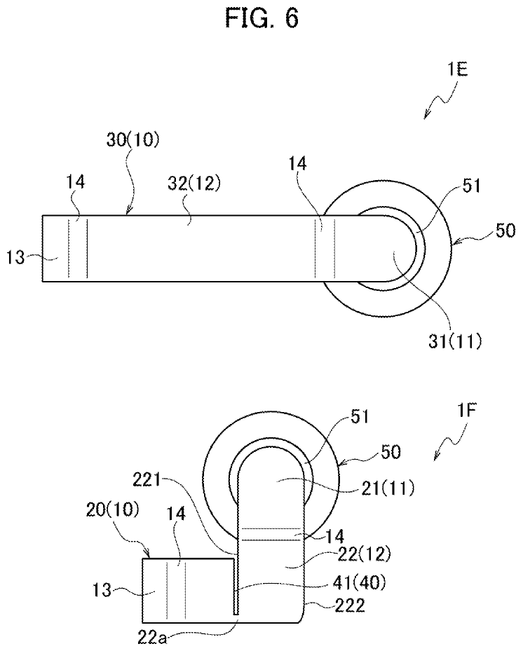

In the fourth embodiment, two batteries (connection target objects) 50 are connected using two busbars, that is, a busbar 1E and a busbar 1F, as illustrated in FIG. 6.

Specifically, the busbar 1E has one busbar part 10, and the busbar 1F has one busbar part 10.

Further, the busbar 1E has one second busbar part 30, and the busbar 1F has one first busbar part 20. Thus, in the present embodiment, the busbar 1E and the busbar 1F have two types (plural types) of busbar parts.

Further, the battery 50 (connection target object) is connected to the connection part 11 (a second connection part 31) of the busbar 1E, and the battery 50 (connection target object) is connected to the connection part 11 (a first connection part 21) of the busbar 1F.

A slit 41 is formed as a current diverting part 40 in the first conductive part 22 of the busbar 1F.

This reduces the variation between the resistance value of the first conductive part 22 of the busbar 1F and the resistance value of the second conductive part 32 of the busbar 1E, and thus the amount of heat generated per unit time 10 is made almost equal in the two busbar parts.

This makes it possible for the configuration of the fourth embodiment to have the same functional effect as those of the first to the third embodiments.

The shape of the slit 41 formed in the first conductive part 22 need not be the shape illustrated in the above first to third embodiments, and the slit 41 may have various shapes.

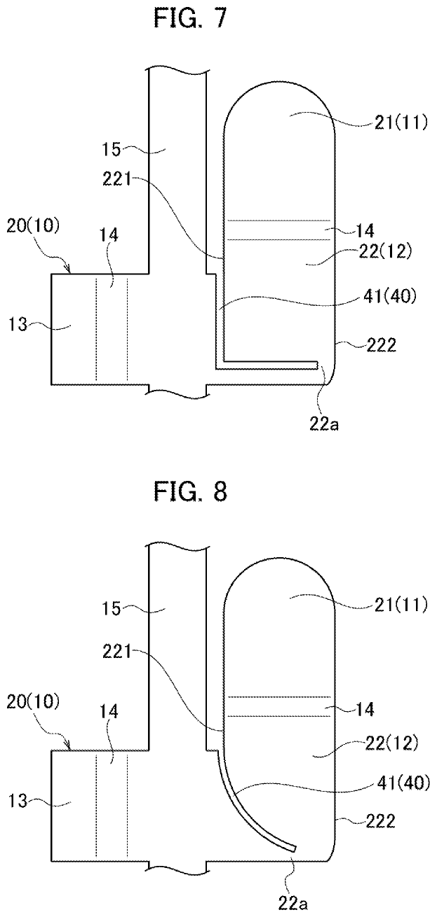

For example, the slit 41 may be bent in an L-shape as illustrated in FIG. 7, or the slit 41 may be formed in an arc-shape as illustrated in FIG. 8. In addition, the slit 41 may be formed by combining straight lines and arcs.

### Function and Effect

In the following description, the characteristic configuration of the busbar illustrated in each of the above embodiments and the modified examples thereof, and the effect obtained therefrom will be described.

The busbars 1, 1A, 1B, 1D, and IF illustrated in each of the above embodiments and the modified examples thereof include the first busbar part 20 having the first connection part 21 that is connected to a battery 50 and the first conductive part 22 that is connected continuous to the first connection part 21. Further, the busbars 1, 1A, 1B, 1D, and IF include the second busbar part 30. The second busbar part 30 has the second connection part 31 connected to a battery 50 different from the battery 50 that is connected to the first connection part 21, and the second conductive part 32 that is connected continuous to the second connection part 31 and has a greater resistance value than that of the first conductive part 22. Further, the current diverting part 40 that diverts a current is formed in the first conductive part 22 such that the shortest path of the current flowing through the first conductive part 22 increases in length, thereby increasing the amount of heat generated in the first conductive part 22 to be more than when the current diverting part 40 is not formed.

As described above, when the current diverting part 40 is formed in the first conductive part 22, the resistance value of the first conductive part 22 becomes greater than when the current diverting part 40 is not formed. As a result, the amount of heat generated in the first conductive part 22 becomes greater than when the current diverting part 40 is not formed, and the amount of heat generated in the first conductive part 22 becomes closer to the amount of heat generated in the second conductive part 32. That is, the difference between the amount of heat generated in the first conductive part 22 and the amount of heat generated in the second conductive part 32 becomes smaller.

Accordingly, the amount of heat transferred from the first conductive part 22 to the battery 50 that is connected to the first connection part 21 becomes closer to the amount of heat transferred from the second conductive part 32 to the battery 50 that is connected to the second connection part 31. As a result, it is possible to reduce the variation in the load (deterioration rate due to heat) applied to the battery 50 that is connected to the first connection part 21 and the battery 50 that is connected to the second connection part 31.

Therefore, even when using the busbars 1, 1A, 1B, 1D, and 1F having a plurality of types of busbar parts (the first and second busbar parts 20 and 30), it is possible to suppress the variation in the load (deterioration rate due to heat) applied to the plurality of batteries 50.

In addition, when it is possible to suppress the variation in the deterioration rate due to the heat of the plurality of batteries 50, the lifespan of the devices using the plurality of batteries 50 (for example, a battery pack) can be extended. That is, when the deterioration rate due to the heat of the plurality of batteries 50 is made more uniform, the lifespan of the devices using the plurality of batteries 50 can be further extended.

For example, if the amount of heat transferred to a plurality of batteries is not adjusted and remains different, the heat will be concentrated in one battery. Thereafter, if the heat is concentrated in the one battery, the deterioration of the battery in which the heat is concentrated progresses, causing the voltage to drop, and a current from another battery may flow into the one battery and causes the current in the one battery to increase, thereby causing the battery to no longer work. Further, if the heat is concentrated in one battery, the solution in the one battery in which the heat is concentrated may be depleted, causing the battery to no longer work. Accordingly, if the heat is concentrated in one battery, the deterioration of the battery may progress beyond the deterioration rate caused by the heat, causing the lifespan of the devices using the plurality of batteries 50 to shorten.

In this respect, the busbar may be configured to have a fuse function that allows other batteries to be used by disconnecting a battery that is no longer usable due to the lifespan thereof. However, disconnecting a battery that is no longer usable due to the lifespan thereof will increase the current load on other batteries, thereby shortening the lifespan of other batteries and thus shortening the lifespan of the devices using the plurality of batteries 50.

In contrast, when the deterioration rate due to the heat of the plurality of batteries 50 is made more uniform, a large current load that is applied to some batteries is suppressed, and thus it is possible to suppress a shortening in the lifespan of the devices using the plurality of batteries 50. As a result, the lifespan of the devices using the plurality of batteries 50 can be extended.

In addition, when the current diverting part 40 is formed in the first conductive part 22, the amount of heat generated in the first conductive part 22 can be adjusted without enlarging the area where the first conductive part 22 is disposed. For this reason, even when the length or width of the first conductive part 22 cannot be changed due to the constraints of other components or the like, the amount of heat generated in the first conductive part 22 can be adjusted. Therefore, the amount of heat generated in the first conductive part 22 can be adjusted after the length or width of the busbar part is predetermined.

In addition, the amount of heat generated in the first conductive part 22 may be substantially equal to the amount of heat generated in the second conductive part 32.

Accordingly, the amount of heat transferred from the first conductive part 22 to the battery 50 that is connected to the first connection part 21 becomes even closer to the amount of heat transferred from the second conductive part 32 to the battery 50 connected to the second connection part 31. As a result, it is possible to decrease the variation in the deterioration rate due to the heat of the battery 50 connected to the first connection part 21 and the battery 50 connected to the second connection part 31. That is, the variation in the deterioration rate due to the heat of the plurality of batteries 50 can be more reliably suppressed, thus making the deterioration rate of the plurality of batteries more uniform.

In addition, the current diverting part 40 may have the slit 41.

This makes it possible to adjust the amount of heat generated in the first conductive part 22 more easily and simplify the configuration. In addition, it is possible to reduce the weights of the busbars 1, 1A, 1B, 1D, and 1F by providing the slit 41 in the first conductive part 22.

In addition, the busbars 1, 1A, 1B, and 1D may further include the coupling part 15 that connects the first conductive part 22 and the second conductive part 32.

Accordingly, since the first busbar part 20 and the second busbar part 30 are integrated, each of the busbars 1, 1A, 1B, and 1D can be arranged in a predetermined position more easily.

In addition, the battery 50 that is connected to the first connection part 21 and the battery 50 that is connected to the second connection part 31 may be connected in parallel.

This prevents the generated heat from being concentrated in some busbar parts in the parallel circuit, thus making the heat generated in each busbar more uniform.

In addition, the first conductive part 22 and the second conductive part 32 may substantially be the same in width and thickness, and the first conductive part 22 may have a shorter length than the second conductive part 32.

Accordingly, the busbars 1, 1A, 1B, 1D, 1F can be manufactured by processing a single metal plate, and thus the busbars 1, 1A, 1B, 1D, 1F can be manufactured more easily.

In addition, the busbars 1, 1A, 1B, 1D, 1F illustrated in each of the above embodiments and the modified examples thereof include the first busbar part 20 having the first connection part 21 that is connected to the connection target object (the battery 50) and the first conductive part 22 that is connected continuous to the first connection part 21. The busbars 1, 1A, 1B, 1D, 1F include the second busbar part 30. The second busbar part 30 has the second connection part 31 that is connected to the connection target object (another battery 50) different from the connection target object (battery 50) that is connected to the first connection part 21. Further, the second busbar part 30 has the second conductive part 32 that is connected continuous to the second connection part 31 and has a greater resistance value than that of the first conductive part 22. Further, the current diverting part 40 that diverts a current is formed in the first conductive part 22 such that the shortest path of the current flowing through the first conductive part 22 increases in length.

As described above, when the current diverting part 40 is formed in the first conductive part 22, the resistance value of the first conductive part 22 becomes closer to the resistance value of the second conductive part 32 by increasing the resistance value of the first conductive part 22. As a result, it is possible to reduce the variation in load (the current value flowing through the connection target object (battery 50)) that is applied to the connection target object (battery 50) that is connected to the first connection part 21 and the connection target object (battery 50) that is connected to the second connection part 31.

Therefore, even when the busbars 1, 1A, 1B, 1D, and 1F having a plurality of types of busbar parts (the first and second busbar parts 20 and 30) are used, the variation in the load that is applied to the plurality of connection target objects (batteries 50) can be suppressed.

In addition, when a voltage sensor is provided to sense, by using a voltage value, that an abnormality has occurred in the connection target object (battery 50) and a difference has occurred in the amount of current flowing to the plurality of connection target objects (batteries 50), the following functions and effects can be achieved. First, when the difference in the amount of current flowing to the plurality of connection target objects (battery 50) is too small to be detected using the voltage value detected by the voltage sensor, the voltage value of each conductive part can be adjusted by adjusting the shape and the number of the current diverting parts 40 and thus changing the resistance value. Moreover, when the voltage value of each conductive part is made to be the same as that of the part detected by the voltage sensor, the voltage value of each conductive part becomes the same as the voltage value detected by the voltage sensor, and thus the threshold of the voltage sensor can be easily determined. This makes it possible to further improve the accuracy of the abnormality determination performed by the voltage sensor.

In addition, when the resistance value of each conductive part is made uniform, the voltage change when performing sensing according to a voltage drop can be easily grasped.

In addition, when a slit is formed in the conductive part 12, the resonance frequency will also change. For this reason, in a case where it is necessary to have a fixed configuration due to dimensional constraints or the like, when the conductive part 12 has a length with which the conductive part 12 resonates due to external vibration, the conductive part 12 can be formed into a shape to avoid the resonance point by forming the slit in the conductive part 12.

### OTHER MODIFIED EXAMPLES

Although the present embodiments have been described as above, the present disclosure is not limited to these configurations and various modified examples are possible within the scope of the gist of the present disclosure.

For example, the configurations described in each of the above embodiments and the modified examples thereof may be combined as appropriate.

Further, in each of the above embodiments and the modified examples thereof, although a description has been given regarding an example in which a busbar is not provided with a portion that is fused in a case where an overcurrent flows, a busbar may be provided with a fuse function by providing a portion that is fused in a case where an overcurrent flows. In this case, it is preferable that each busbar part have a fuse function.

Further, in each of the above embodiments and the modified examples thereof, the current diverting part is formed only in the first busbar part from among the first and second busbar parts; however, the current diverting part may be formed in both the first and second busbar parts. In this case, it is preferable that the amount of increase in the resistance value of the first busbar part be greater than the amount of increase in the resistance value of the second busbar part.

Further, in each of the above embodiments and the modified examples thereof, although a description has been given regarding an example in which a busbar has two types of busbar parts, it is also possible to use a busbar having three or more types of busbar parts. In this case, it is preferable that the resistance value of each busbar part be more uniform by appropriately setting the shape and the number of current diverting parts which are provided in each busbar part.

Further, in each of the above embodiments and the modified examples thereof, although a description has been given regarding an example in which the connection target object is a battery, it is also possible to use a connection target object other than a battery. As a connection target object other than a battery, for example, it is possible to use a member whose life is shortened by the amount of heat to be transferred. Such a member may be an electronic component such as an LED, an IC, and a transistor, or a plastic material. In addition, it is possible to use a busbar that is connected to two or more types of connection target objects selected from a plurality types of connection target objects including batteries.

Further, the first and second connection parts, the first and second conductive parts, and the other detailed specifications (shape, size, layout, etc.) can be changed as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A busbar comprising:
a first busbar part having a first connection part that is connected to a battery, and a first conductive part that is connected continuous to the first connection part; and
a second busbar part having a second connection part that is connected to a battery different from the battery that is connected to the first connection part, and a second conductive part that is connected continuous to the second connection part and has a greater resistance value than that of the first conductive part,
wherein a current diverting part that diverts a current is formed in the first conductive part such that a shortest path of the current flowing through the first conductive part increases in length, thereby increasing an amount of heat generated in the first conductive part to be more than when the current diverting part is not formed.

2. The busbar according to claim 1, wherein
the amount of heat generated in the first conductive part is substantially equal to an amount of heat generated in the second conductive part.

3. The busbar according to claim 1, wherein
the current diverting part has a slit.

4. The busbar according to claim 1, further comprising:
a coupling part that connects the first conductive part and the second conductive part.

5. The busbar according to claim 4, wherein
the battery that is connected to the first connection part and the battery that is connected to the second connection part are connected in parallel.

6. The busbar according to claim 1, wherein
the first conductive part and the second conductive part are substantially the same in width and thickness, and the first conductive part has a shorter length than the second conductive part.

7. A busbar comprising:
a first busbar part having a first connection part that is connected to a connection target object, and a first conductive part that is connected continuous to the first connection part; and
a second busbar part having a second connection part that is connected to a connection target object different from the connection target object that is connected to the first connection part, and a second conductive part that is connected continuous to the second connection part and has a greater resistance value than that of the first conductive part,
wherein a current diverting part that diverts a current is formed in the first conductive part such that a shortest path of the current flowing through the first conductive part increases in length.

8. The busbar according to claim 7, wherein
the current diverting part has a slit.

9. The busbar according to claim 7, further comprising:
a coupling part that connects the first conductive part and the second conductive part.

10. The busbar according to claim 7, wherein
the first conductive part and the second conductive part are substantially the same in width and thickness, and the first conductive part has a shorter length than the second conductive part.
